(19) United States
(12) Patent Application Publication
(10) Pub. No.: US 2012/0049682 A1
(43) Pub. Date: Mar. 1, 2012

(54) MAGNETIC GEAR

(75) Inventors: GUO-QING ZHANG, Shenzhen City (CN); CHIA-PENG DAY, Santa Clara, CA (US)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/170,359

(22) Filed: Jun. 28, 2011

(30) Foreign Application Priority Data
Aug. 27, 2010 (CN) 201010264809.7

(51) Int. Cl. H02K 49/10

(52) U.S. Cl. 310/103

(57) ABSTRACT

A magnetic gear includes a gear base, magnetic members, rotating members, operating members, and a cover. Each magnetic member is a bar magnet. The magnetic members are rotatably positioned on the gear base, and a rotation axis of the magnetic member is substantially parallel to an axis of the magnetic gear. The rotating members are also received in the gear base. The cover is fixed to the gear base, and defines a plurality of through holes corresponding to the magnetic members. The gear base includes a connecting plate. Magnetic torque between two magnetic gears and also the transmission ratio of the corresponding magnetic gears can be both changed by rotating the operating members together with the magnetic members and the rotating members, and by having the rotating member resisting a different restricting surface of the connecting plate.

### BACKGROUND

1. Technical Field

The present disclosure relates generally to magnetic gears, more particularly, to a magnetic gear for a transmission mechanism.

2. Description of Related Art

A magnetic gear is a new type of gear, it utilizes magnetic force to transmit torque. In the transmission of torque by the magnetic gears, the adjacent magnetic gears do not touch each other, and thus no friction and no wear is generated, thereby eliminating the friction loss and mechanical fatigue. Consequently, the magnetic gears is widely used in transmission mechanisms. However, the gear transmission ratio of two magnetic gears is generally fixed. If the transmission ratio needs to be changed, the original magnetic gears should be replaced by another pair of suitable magnetic gears, and thus a plurality of magnetic gears need to be prepared for each one transmission mechanism.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a magnetic gear.

FIG. 2 an exploded, isometric view of the magnetic gear of FIG. 1.

FIG. 3 is an isometric view of a gear base of FIG. 1.

FIG. 4 is a partial, cross-section of the magnetic gear of FIG. 1, taken along line IV-IV.

### DETAILED DESCRIPTION

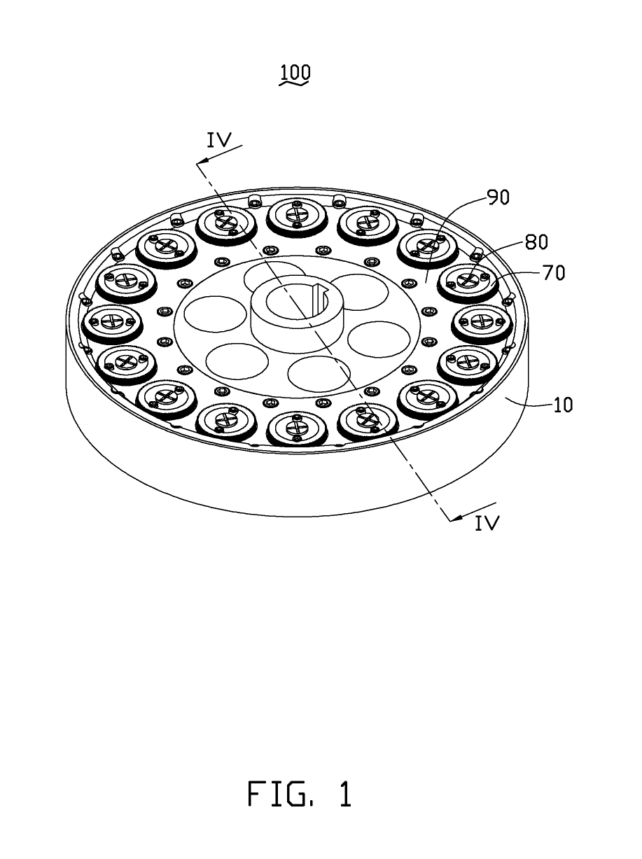

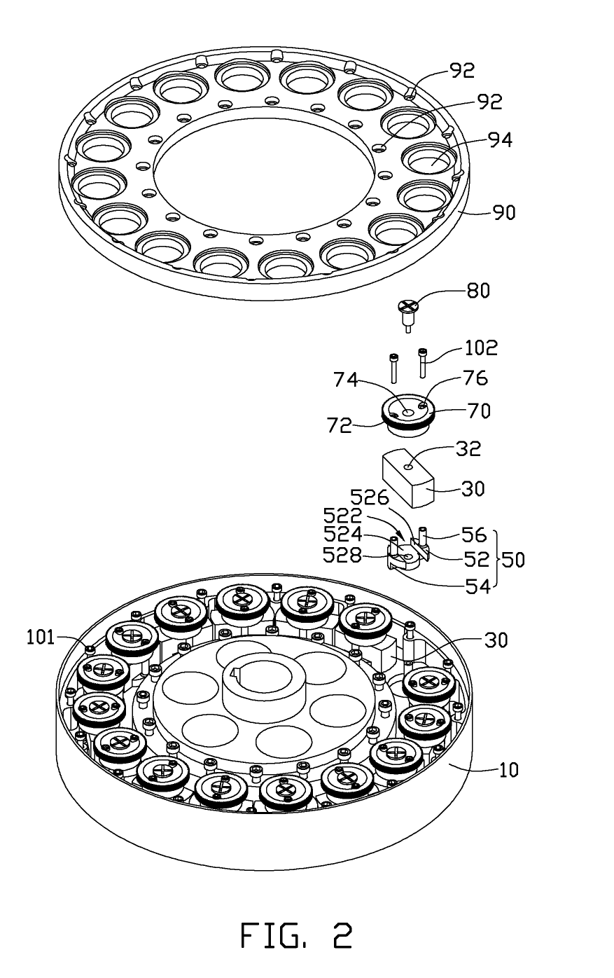

Referring to FIGS. 1 and 2, an embodiment of a magnetic gear 100 includes a gear base 10, a plurality of magnetic members 30, a plurality of rotating members 50, a plurality of operating members 70, a plurality of fixing members 80, and a cover 90. The magnetic members 30 and the rotating members 50 are received in the gear base 10. The fixing members 80 position the magnetic members 30, the rotating members 50, and the operating members 70 in the gear base 10. The cover 90 is positioned on the gear base 10.

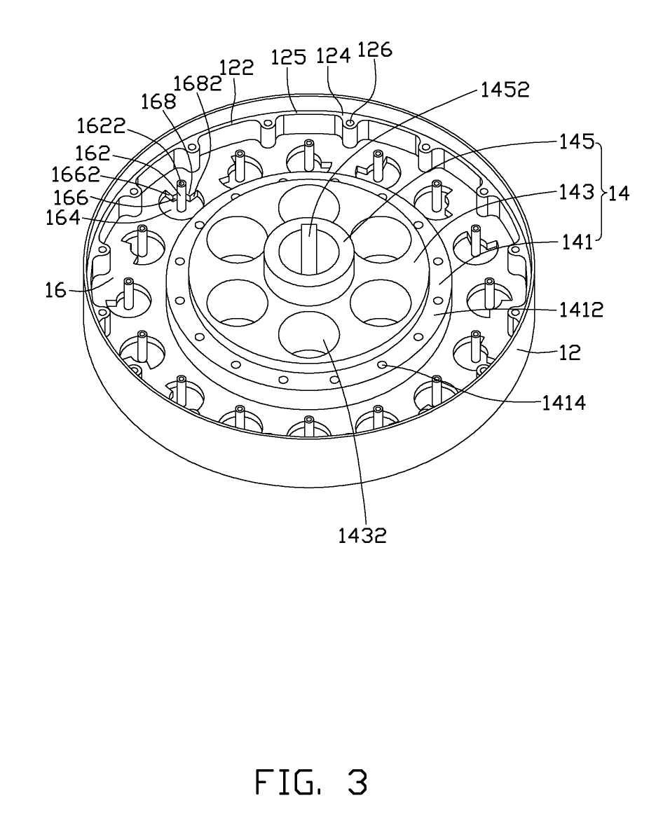

Referring to FIG. 3, the gear base 10 includes a gear flange 12, a gear hub 14, and a connecting plate 16. The connecting plate 16 connects the gear flange 12 to the gear hub 14, such that the gear flange 12 is indirectly sleeved on the gear hub 14. The gear flange 12 is substantially hollow cylindrical, and includes a positioning portion 122 and a plurality of fixing protrusions 124. The positioning portion 122 extends from the inner surface of the gear flange 12 towards the center of the positioning portion 122, and forms a positioning surface 125 in a top edge of the positioning portion 122. Each fixing protrusion 124 protrudes from the inner surface of the positioning portion 122 towards the center of the positioning portion 122, and defines a fixing hole 126.

The gear hub 14 includes a fixing portion 141, a connecting portion 143, and a shaft portion 145. The fixing portion 141 is substantially cylindrical, and forms a resisting surface 1412 at a top edge of the fixing portion 141. The resisting surface 1412 is coplanar with the positioning surface 125. The resisting surface 1412 defines a plurality of fixing holes 1414. In the illustrated embodiment, the fixing holes 1414 are evenly arranged in the resisting surface 1412, and positioned in one same circle. The connecting portion 143 is substantially cylindrical, and formed above the resisting surface 1412. The connecting portion 143 defines a plurality of through holes 1432 extending through the connecting portion 143 and the fixing portion 141, and thereby reducing a weight of the gear hub 14. The shaft portion 145 is substantially cylindrical, and extends axially from a center portion of the connecting portion 143. The fixing portion 141, the connecting portion 143, and the shaft portion 145 are aligned in a straight line. The shaft portion 145 defines a pivot hole 1452 extending through the shaft portion 145, the connecting portion 143 and the fixing portion 141.

The connecting plate 16 is annular, and defines a plurality of positioning posts 162. Each positioning post 162 is positioned between two adjacent fixing protrusions 124, and defines a threaded hole 1622. The connecting plate 16 further includes a plurality of receiving portions 164, a plurality of first restricting portions 166, a plurality of second restricting portions 168. Each receiving portion 164 is defined in the connecting plate 16, and around one corresponding positioning post 162. One first restricting portion 166 and one second restricting portion 168 are formed in the receiving portion 164. The first restricting portion 166 forms a first restricting surface 1662 perpendicular to the connecting plate 16, and the second restricting portion 168 forms a second restricting surface 1682 perpendicular to the connecting plate 16. The first restricting surface 1662 is substantially perpendicular to the second restricting portion 168.

A total number of the magnetic members 30 is equal to the total number of receiving portions 164 of the connecting plate 16. In this embodiment, each magnetic member 30 is a bar magnet and has a south pole and a north pole at opposite ends thereof. The magnetic member 30 further defines a connecting hole 32 corresponding to one positioning post 162.

Referring to FIG. 2 again, each rotating member 50 includes a grasping portion 52, a resisting portion 54, and two fastening portions 56. The resisting portion 54 and the fastening portion 56 are formed on opposite ends of the grasping portion 52. The grasping portion 52 forms a grasping groove 522, which is cooperatively defined by a bottom surface 524 and two grasping surfaces 526 perpendicular connecting to opposite sides of the bottom surface 524. The bottom surface 524 defines a receiving hole 528 corresponding to one positioning post 162. In the illustrated embodiment, the resisting portion 54 is strip-shaped, and perpendicular to the grasping surfaces 526. The fastening portions 56 are studs.

Each operating member 70 forms a friction portion 72 at an end, and defines a pivot hole 74 and two connecting holes 76. The friction portion 72 is composed of a plurality of protrusions arranged in a circle. The pivot hole 74 and the connecting holes 76 are aligned in a straight line, and the pivot hole 74 is positioned between the connecting holes 76. Each fixing member 80 is a screw corresponding to the positioning post 162.

Referring to FIGS. 2 and 3, the cover 90 is annular, and defines a plurality of fixing holes 92 corresponding to the fixing holes 126 of the gear base 10, and a plurality of through holes 94 corresponding to the positioning posts 162 of the connecting plate 16.

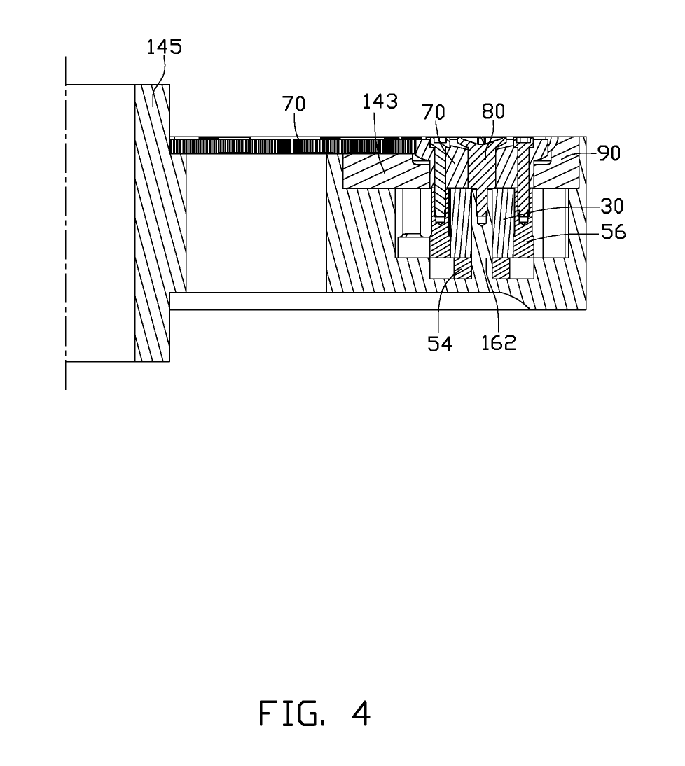

Referring to FIG. 4, in the assembly of the magnetic gear 100, the rotating members 50 are positioned in the receiving portions 164 of the connecting plate 16, with the positioning posts 162 engaging in and extending out of the receiving holes 528 of the rotating members 50, and the resisting portions 54 resisting the first restricting surface 1662. The magnetic members 30 are positioned in the grasping grooves 522 of the rotating members 50, with either one of the south pole or the north pole of each magnetic member 30 pointing towards the shaft portion 145, and the other one of the south pole or the north pole of each magnetic member 30 pointing towards the gear flange 12. The cover 90 is received in the gear base 10, and resisted by the positioning surface 125 of the positioning portion 122. The cover 90 is further fixed to the gear base 10 via a plurality of first fasteners 101. The operating members 70 are fixed to the rotating members 50 one by one with a plurality of second fasteners 102, and thereby holding the magnetic members 30 tightly between the rotating members 50 and the operating members 70. The fixing members 80 extend through the pivot hole 74, and are threaded into the threaded holes 1622, and thereby fixing the operating members 70 to the gear base 10. Then, the magnetic members 30, the rotating members 50, the operating members 70 are respectively fixed to the gear base 10.

When two magnetic gears 100 are employed, an attraction magnetic force or a repulsion magnetic force can be generated, and thus a torque is transmitted without friction. If the transmission ratio of the magnetic gears 100 needs to be changed, the fixing members 80 are loosened from the operating members 70, and the operating members 70 can be rotated together with the magnetic members 30 and the rotating members 50. A rotation axis of the magnetic member 30 is substantially parallel to a rotation axis of the magnetic gear 100. When the rotating members 50 resist the second restricting surface 1682, the magnetic member 30 is rotated through 90 degrees. As a result, a magnetic torque between the magnetic gears 100 is changed, and thus the transmission ratio of the magnetic gears 100 is changed.

The positioning portion 122 may be omitted in the magnetic gear 100, and the cover 90 can be directly attached to a top edge of the gear flange 12. The receiving portions 164 may be omitted in the connecting plate 16, and the first restricting portions 166 and the second restricting portion 168 protrude from the connecting plate 16. Furthermore, the first restricting portions 166 and the second restricting portion 168 can be omitted, and correspondingly, the rotating members 50 is also omitted.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A magnetic gear, comprising:
a gear base;
a plurality of magnetic members, each magnetic member being a bar magnet;
wherein the magnetic members are rotatably positioned on the gear base, and a rotation axis of each magnetic member is substantially parallel to a rotation axis of the magnetic gear.

2. The magnetic gear of claim 1, further comprising a plurality of fixing members, wherein the magnetic members define a plurality of connecting holes, respectively, and the gear base defines a plurality of threaded holes, the fixing members extend through the connecting holes of the magnetic members, and are threaded into the threaded holes of the gear base.

3. The magnetic gear of claim 2, further comprising a plurality of operating members, wherein each operating member defines a pivot hole being extended through by one fixing member, thereby connecting the operating members to the magnetic members and fixing the operating members to the gear base.

4. The magnetic gear of claim 3, wherein each operating member forms a friction portion at an end, and the friction portion is comprised of a plurality of protrusions arranged in a circle.

5. The magnetic gear of claim 3, further comprising a plurality of rotating members, wherein each rotating member defines a receiving hole being extended into by one fixing member, thereby positioning the magnetic members between the operating members and the rotating members, and the rotating members is attached to the gear base.

6. The magnetic gear of claim 5, wherein each rotating member defines a grasping groove, which is cooperatively defined by a bottom surface and two grasping surfaces perpendicular connecting to opposite sides of the bottom surface, and the magnetic members are positioned in the grasping grooves of the rotating member.

7. The magnetic gear of claim 5, wherein the gear base forms a plurality of positioning posts, and the fixing members are fixed to the positioning post.

8. The magnetic gear of claim 5, wherein each rotating member has a resisting portion, the gear base forms a plurality of first restricting portions and a plurality of second restricting portions, and the rotating members rotate together with the magnetic members to make the resisting portion resist the first restricting portions or the second restricting portions.

9. The magnetic gear of claim 1, wherein the gear base comprises a gear flange, a gear hub, and a connecting plate, the gear flange is sleeved on the gear hub, and the connecting plate connects the gear flange to the gear hub, the magnetic members are positioned on the connecting plate.

10. The magnetic gear of claim 9, further comprising a cover fixed to the gear flange, the cover defines a plurality of through holes corresponding to the magnetic members.

11. The magnetic gear of claim 9, wherein the gear hub comprises a fixing portion, a connecting portion, and a shaft portion aligned in a straight line, and the shaft portion defines a pivot hole extending through the shaft portion, the connecting portion and the fixing portion.

12. A magnetic gear, comprising:
a gear base;
a plurality of rotating members rotatably positioned on the gear base;
a plurality of magnetic members grasped by the rotating members;
a plurality of fixing members extending through the magnetic members and the rotating members, and fixed to the gear base.

13. The magnetic gear of claim 12, further comprising a plurality of operating members, wherein each operating member defines a pivot hole being extended through by one fixing member, thereby connecting the operating members to the magnetic members and fixing the operating members to the gear base.

14. The magnetic gear of claim 13, wherein each operating member forms a friction portion at an end, and the friction portion is comprised of a plurality of protrusion arranged in a circle.

15. The magnetic gear of claim 12, wherein each rotating member defines a grasping groove, which is cooperatively defined by a bottom surface and two grasping surfaces perpendicular connecting to opposite sides of the bottom surface, and the magnetic members are positioned in the grasping grooves of the rotating member.

16. The magnetic gear of claim 12, wherein the gear base forms a plurality of positioning post, and the fixing members are fixed to the positioning post.

17. The magnetic gear of claim 12, wherein each rotating member has a resisting portion, the gear base forms a plurality of first restricting portions and a plurality of second restricting portions, and the rotating members rotate together with the magnetic members to make the resisting portion resist the first restricting portions or the second restricting portions.

18. The magnetic gear of claim 12, wherein the gear base comprises a gear flange, a gear hub, and a connecting plate, the gear flange is sleeved on the gear hub, and the connecting plate connects the gear flange to the gear hub, the magnetic members are positioned on the connecting plate.

19. The magnetic gear of claim 18, further comprising a cover fixed to the gear flange, the cover defines a plurality of through holes corresponding to the magnetic members.

20. The magnetic gear of claim 18, wherein the gear hub comprises a fixing portion, a connecting portion, and a shaft portion aligned in a straight line, and the shaft portion defines a pivot hole extending through the shaft portion, the connecting portion and the fixing portion.
